(19) United States
(12) Patent Application Publication
(10) Pub. No.: US 2026/0320434 A1
(43) Pub. Date: Oct. 15, 2026

(54) INFERENCE METHOD, INFERENCE SYSTEM, AND STORAGE MEDIUM

(71) Applicant: Lenovo (Beijing) Limited, Beijing (CN)

(72) Inventors: Xin MA, Beijing (CN); Peng WANG, Beijing (CN); Dongdong XU, Beijing (CN)

(21) Appl. No.: 19/312,555

(22) Filed: Aug. 28, 2025

(30) Foreign Application Priority Data
Aug. 30, 2024 (CN) 202411220183.8

(51) Int. Cl. G06N 5/04

(52) U.S. Cl. CPC G06N 5/04

(57) ABSTRACT

An inference method includes obtaining inquiry information, executing a current inference sub-task in an inference task corresponding to the inquiry information, to obtain an inference sub-result of the current inference sub-task, evaluating the inference sub-result to obtain an evaluation result of the inference sub-result, when it is determined that the evaluation result satisfies processing criteria, processing the inference sub-result to obtain a processed result of the current inference sub-task, and based on the inquiry information and the processed result of the current inference sub-task, executing a next inference sub-task following the current inference task, so as to determine an inference result corresponding to the inquiry information based on at least an inference sub-result of a final inference sub-task.

### CROSS-REFERENCE TO RELATED APPLICATION

This application claims priority to Chinese Patent Application No. 202411220183.8, filed on Aug. 30, 2024, the content of which is incorporated herein by reference in its entirety.

### TECHNICAL FIELD

The application relates to the field of artificial intelligence technology, in particular to the fields of large models, generative models, etc. More specifically, the application provides an inference method of an inference system, an inference method, and an inference system.

### BACKGROUND

Inference systems may be used to perform inference tasks, such as answering user queries. However, current large language models operate as “black boxes” with limited visibility into their inference process, reducing trust and reliability.

### SUMMARY

In one embodiment, the present disclosure provides an inference method for an inference system, the method including: obtaining inquiry information, where the inference system includes an inference module, an evaluation module, and a processing module; executing, through the inference module, a current inference sub-task of an inference task corresponding to the inquiry information, to obtain a reference sub-result of the current inference sub-task; evaluating, through the evaluation module, the reference sub-result to obtain an evaluation result of the reference sub-result; when it is determined that the evaluation result satisfies processing criteria, processing, through the processing module, the reference sub-result to obtain a processed result of the current inference sub-task; and based on the inquiry information and the processed result of the current inference sub-task, executing, through the inference module, a next inference sub-task following the current inference task, so as to determine an inference result corresponding to the inquiry information based on at least a reference sub-result of a final inference sub-task.

In another embodiment, the present disclosure provides an inference method, including: obtaining inquiry information; executing a current inference sub-task in an inference task corresponding to the inquiry information, to obtain an inference sub-result of the current inference sub-task; evaluating the inference sub-result to obtain an evaluation result of the inference sub-result; when it is determined that the evaluation result satisfies processing criteria, processing the inference sub-result to obtain a processed result of the current inference sub-task; and based on the inquiry information and the processed result of the current inference sub-task, executing a next inference sub-task following the current inference task, so as to determine an inference result corresponding to the inquiry information based on at least an inference sub-result of a final inference sub-task.

In another embodiment, the present disclosure provides an inference system, including a memory and one or more processors, where the memory stores a computer program executable by the one or more processors, and when executing the computer program, the one or more processor are configured to perform: obtaining inquiry information; executing a current inference sub-task in an inference task corresponding to the inquiry information, to obtain an inference sub-result of the current inference sub-task; evaluating the inference sub-result to obtain an evaluation result of the inference sub-result; when it is determined that the evaluation result satisfies processing criteria, processing the inference sub-result to obtain a processed result of the current inference sub-task; and based on the inquiry information and the processed result of the current inference sub-task, executing a next inference sub-task following the current inference task, so as to determine an inference result corresponding to the inquiry information based on at least an inference sub-result of a final inference sub-task.

In another embodiment, the present disclosure provides a non-transitory computer-readable storage medium containing a computer instruction that, when being executed, causes the one or more processors to perform: obtaining inquiry information; executing a current inference sub-task in an inference task corresponding to the inquiry information, to obtain an inference sub-result of the current inference sub-task; evaluating the inference sub-result to obtain an evaluation result of the inference sub-result; when it is determined that the evaluation result satisfies processing criteria, processing the inference sub-result to obtain a processed result of the current inference sub-task; and based on the inquiry information and the processed result of the current inference sub-task, executing a next inference sub-task following the current inference task, so as to determine an inference result corresponding to the inquiry information based on at least an inference sub-result of a final inference sub-task.

It should be understood that the content described in this section is not intended to identify the key or important features of the embodiments of the present disclosure, nor is it intended to limit the scope of the present disclosure. Other features of the present disclosure will become easily understood through the following brief description of the drawings and the detailed description.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flowchart of an inference method of an inference system according to an embodiment of the present disclosure.

FIG. 2 is a schematic diagram of an inference module executing an inference sub-task according to an embodiment of the present disclosure.

FIG. 3 is a schematic diagram of manual error correction according to an embodiment of the present disclosure.

FIG. 4 is a schematic diagram of an inference method of an inference system according to an embodiment of the present disclosure.

FIG. 5 is a flowchart of an inference method according to an embodiment of the present disclosure. and

FIG. 6 is a schematic structural diagram of an inference system according to an embodiment of the present disclosure.

FIG. 7 is a schematic structural diagram of an electronic device for implementing the inference method of the inference system according to an embodiment of the present disclosure.

### DETAILED DESCRIPTION

The following description of exemplary embodiments of the present disclosure is made in conjunction with the accompanying drawings, including various details of the embodiments of the present disclosure to facilitate understanding. These details should be considered as merely exemplary. Therefore, those skilled in the art will recognize that various changes and modifications may be made to the embodiments described herein without departing from the scope and spirit of the present disclosure. Similarly, for the sake of clarity and conciseness, descriptions of well-known functions and structures are omitted in the following description.

In the technical solutions disclosed herein, the collection, storage, use, processing, transmission, provision and disclosure of user personal information involved comply with the provisions of relevant laws and regulations and do not violate public order and good morals.

In the technical solution disclosed herein, a user's authorization or consent is obtained before obtaining or collecting the user's personal information.

In some embodiments, an inference system may be used to perform inference tasks. The inference system may include an inference module, which may include a large language model. For example, a user inputs a question, and the large language model provides an answer. However, because the large language model typically operates as a “black box,” its inference process cannot be effectively observed. This approach results in a relatively ambiguous inference process, resulting in low credibility and reliability.

The disclosed embodiments aim to provide an inference method for an inference system. After obtaining inquiry information, the method, through an inference module, executes a current inference sub-task in the inference task corresponding to the inquiry information to obtain an inference sub-result. The inference sub-result is then evaluated through an evaluation module to obtain an evaluation result. If the evaluation result satisfies processing criteria, the inference sub-result is processed through a processing module to obtain a processed result. The inference module then executes a next inference sub-task following the current inference task based on the inquiry information and the processed result of the current inference sub-task. This method may effectively observe the inference process of the inference module, avoid ambiguity in the inference process, improve the inference credibility of the inference module, and improve the inference accuracy and reliability of the inference module.

The technical solutions provided by the present disclosure will be described in detail below with reference to the accompanying drawings and specific embodiments.

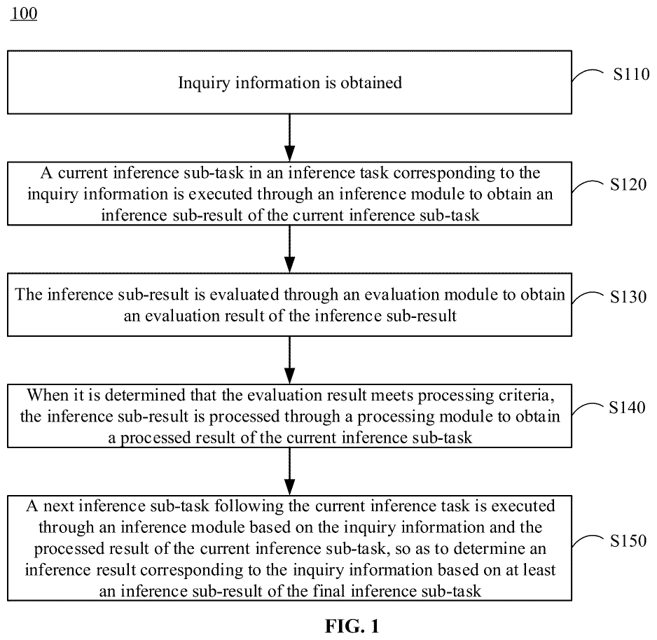

FIG. 1 is a flowchart of an inference method of an inference system according to an embodiment of the present disclosure.

As shown in FIG. 1, the inference system includes an inference module, an evaluation module, and a processing module. The inference method 100 of the inference system may include operations S110 to S150.

In operation S110, inquiry information is obtained.

For example, the inquiry information may be obtained through interaction between the inference system and a user, or an inquiry information database may be pre-defined, and the inquiry information may be selected from the database. The inquiry information may be text, voice, or other data.

For example, the inquiry information may be questions of various types, such as mathematics, general knowledge, and planning. For example, a mathematics question might be “What is the solution to the equation 3X+1=4?”, a general knowledge question might be “Is Beijing a coastal city?”, and a planning question might be “I want to go to Beijing tomorrow. Please give me some clothing suggestions” or “Give me a travel plan for Dalian.”

In operation S120, a current inference sub-task in the inference task corresponding to the inquiry information is executed through the inference module to obtain an inference sub-result of the current inference sub-task.

For example, the inference module may include a large language model (LLM). The inference module may determine an inference task based on inquiry information. The inference task may include multiple inference sub-tasks, and a sequential relationship may exist between the multiple inference sub-tasks.

For example, taking the inquiry information “What is the solution of the equation 3X+1=4?” as an example, one inference sub-task may be “transposing terms” and another inference sub-task may be “division calculation”.

For example, taking the inquiry information “I want to go to Beijing tomorrow, please give me some clothing suggestions” as an example, one inference sub-task may be “Query the weather in Beijing”, and another inference sub-task may be “Provide clothing suggestions based on the weather”.

For example, the inference module may execute multiple inference sub-tasks in sequence, and the execution order of the multiple inference sub-tasks may be sequential and/or in parallel. A current inference sub-task may represent the inference sub-task that needs to be currently executed during the process of the inference module executing the inference sub-tasks in sequence.

For example, an inference sub-result may represent the result obtained through the inference module when executing the inference sub-task. It should be noted that the inference module is limited by its own inference ability, and the inference sub-result may be correct or incorrect. For example, if the inquiry information is “What is the solution of the equation 3X+1=4” and one of the inference sub-tasks is “transposing terms”, when executing this inference sub-task, if the inference sub-result is “3X=3”, it is correct, and if the inference sub-result is “3X=4”, it is incorrect.

In operation S130, the inference sub-result is evaluated through an evaluation module to obtain an evaluation result of the inference sub-result.

For example, the evaluation module may include a pre-trained evaluation model. In one example, a pre-trained large language model may be used as the evaluation model. During the training process, the samples input into the evaluation model may include questions, answers corresponding to the questions, and predetermined prompt information, and the sample labels may be reference answers. The predetermined prompt information may be, for example, “combine the question and answer for evaluation, and evaluate from the aspects of relevance, accuracy, and sensitivity of the question and answer”. The reference answer may be, for example, “the question and answer are related, the relevance confidence is A, the accuracy confidence is B, and the sensitivity confidence is C”. In the process of applying the evaluation model for evaluation, the input of the evaluation model may include the inquiry information and the inference sub-result. In some embodiments, other deep learning models used to perform regression tasks may be used as evaluation models.

For example, the evaluation module may evaluate the inference sub-result based on the inquiry information and the inference sub-result along one or more evaluation aspects. Examples of evaluation aspects include the correctness of the inference sub-result, the correlation between the inference sub-result and the inquiry information, and the sensitivity of the inference sub-result. It is to be noted that the evaluation model may evaluate the inference sub-result along at least one of the three aspects of correctness, relevance, and sensitivity.

For example, the evaluation result may include confidence, which may indicate at least one of the correctness of the inference sub-result, the correlation between the inference sub-result and the inquiry information, and the sensitivity of the inference sub-result.

In operation S140, when it is determined that the evaluation result meets the processing criteria, the inference sub-result is processed through the processing module to obtain a processed result of the current inference sub-task.

In one example, the processing module processing the inference sub-result may include correcting the inference sub-result. For example, if the question is “What is the solution to the equation 3X+1=4?”, the processing module may correct the incorrect inference sub-result “3X=4” to “3X=3.”

In another example, the processing module's processing of the inference sub-result may include combining reference information with the inference sub-result and using the combined information as the processed result. For example, if the question is “What is the solution to the equation 3X+1=4?”, the processing module may combine reference information such as “calculation error,” “accuracy confidence is 0,” and “after evaluation, 3X=3 after transposing the terms,” with the original inference sub-result “3X=4” to obtain the processed result.

In operation S150, a next inference sub-task following the current inference task is executed through the inference module based on the inquiry information and the processed result of the current inference sub-task, so as to determine an inference result corresponding to the inquiry information based on at least the inference sub-result of the final inference sub-task.

For example, the inquiry information corresponds to the inference results one-to-one. Since the inference module performs multiple inference sub-tasks in sequence during the execution of the inference task, the inference sub-result of the final inference sub-task may be used as the inference result corresponding to the inquiry information.

According to the technical solutions provided by the embodiments of the present disclosure, after executing an inference sub-task, the inference module performs evaluation and processing. If a problem arises in an inference sub-result, such as a problem with the correctness, relevance, or sensitivity of the inference sub-result, the inference sub-result may be adjusted to a processed result. The inference module then executes the next inference sub-task based on the processed result, rather than solely on the problematic inference sub-result of the previous inference sub-task.

Based on the above technical solutions, on the one hand, the inference process of the inference module may be effectively observed through the inference sub-result and evaluation result of each inference sub-task, avoiding ambiguity in the inference process and thus improving the inference credibility of the inference module. On the other hand, the processed results may correct the inference sub-results or provide a reference for the inference module to execute the next inference sub-task. In this way, the inference module may correct the subsequent inference process if there is a problem with the previous inference sub-result, avoiding subsequent inference errors caused by problems in the previous inference sub-task, thereby improving the inference accuracy and reliability of the inference module. Moreover, because the processing is performed during the inference process, the intermediate inference sub-results may be corrected, rather than correcting them after the inference results are obtained, which may improve the error correction efficiency.

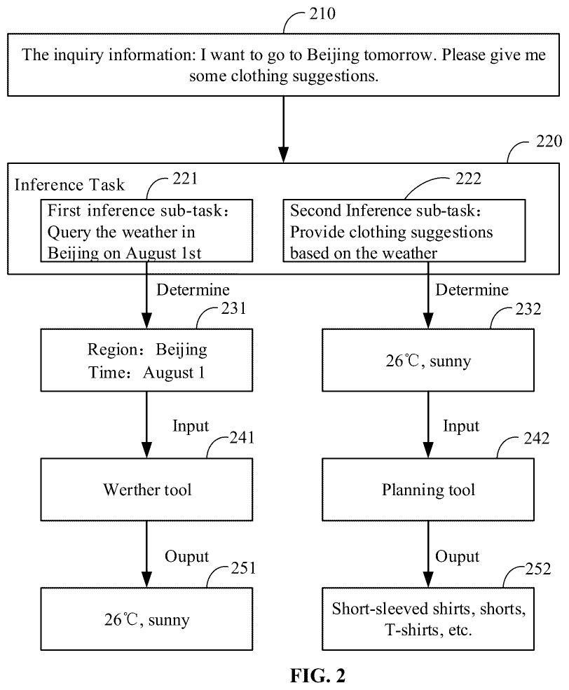

FIG. 2 is a schematic diagram showing the principle of an inference module executing an inference sub-task according to an embodiment of the present disclosure.

According to one embodiment of the present disclosure, the above-mentioned process of executing the inference sub-task through the inference module may include: the inference module determines the execution process based on the inquiry information, then calls a corresponding tool using the parameters determined based on the execution process, and then determines the inference sub-result of the current inference sub-task based on the output information of the tool.

For example, if the inquiry information 210 is “I want to go to Beijing tomorrow. Please give me some clothing suggestions,” the inference module may first determine that inference task 220 includes two inference sub-tasks. The first inference sub-task 221 may be “Query the weather in Beijing on August 1st,” and the second inference sub-task 222 may be “Pla.”

Next, the inference module may first determine the inference sub-tasks that have been executed and the obtained inference sub-results. Since the first inference sub-task 221 has not yet been executed, the execution process at this point may be “Query the weather in Beijing on August 1st.” Through this execution process, it may be determined that parameters 231 include “Region: Beijing, Time: August 1st.” The inference module may call weather tool 241 and use these parameters 231 as the input of weather tool 241. The output information obtained through the weather tool is “26° C., sunny”, which may be used as the inference sub-result 251 of the first inference sub-task.

Next, after obtaining the inference sub-result 251 of the first inference sub-task, the inference sub-result is evaluated. The evaluation result indicates that the inference sub-result 251 does not meet the processing criteria, and the inference sub-result may not be processed at this time.

Next, the second inference sub-task 222 may be executed, and the execution process may be updated to “Provide clothing suggestions based on the weather.” Through this execution process, parameters 232 may be determined to be “26° C., sunny.” The inference module may call the relevant planning tool 242 and use the above parameters 232 as the input of the planning tool 242. The planning tool 242 may obtain the output information “Short-sleeved shirts, shorts, T-shirts, etc.” This “Short-sleeved shirts, shorts, T-shirts, etc.” may be used as the inference sub-result 252 of the second inference sub-task. It is to be noted that this inference sub-result 252 may serve as the inference result corresponding to the above-mentioned inquiry information 210.

The disclosed embodiment explains the working process of the inference module. This embodiment decomposes the inference task into multiple inference sub-tasks, obtains the inference sub-results through calling the corresponding tools, and obtains the inference results after multiple inferences. Compared with the method of obtaining the inference result through performing a single inference, the accuracy of the inference result may be improved.

Next, the evaluation module and evaluation results are explained.

In the disclosed embodiment, the evaluation module may evaluate an inference sub-result based on the inquiry information and the inference sub-result from one or more evaluation aspects, such as the correctness of the inference sub-result, the correlation between the inference sub-result and the inquiry information, and the sensitivity of the inference sub-result.

In one example, the evaluation result may include a confidence level. For example, the evaluation result may include at least one of the following confidence levels: a confidence level indicating the correctness of the inference sub-result, a confidence level indicating the correlation between the inference sub-result and the inquiry information, and a confidence level indicating the sensitivity of the inference sub-result.

When the evaluation result includes a confidence level, the processing criteria, for example, may include: any one of the at least one confidence level is less than or equal to a corresponding confidence threshold. For example, a confidence threshold corresponding to each confidence level may be pre-defined, and an evaluation result is determined to meet the processing criteria if a confidence level is less than or equal to the corresponding confidence threshold.

When the evaluation result includes a confidence level, the processing criteria, in another example, may include: a total confidence level determined based on at least one confidence level is less than or equal to a total confidence level threshold. For example, the total confidence level may be calculated through performing a weighted average operation, a summation operation, or other operations on the at least one confidence level. If the total confidence level is less than or equal to the total confidence level threshold, the evaluation result is determined to meet the processing criteria.

In this example, the evaluation result includes a confidence level, and whether the processing criteria are met is determined based on the confidence level and the corresponding confidence threshold. Confidence levels may accurately measure the quality of the inference sub-results in various aspects, thereby improving the accuracy of the evaluation results.

In another example, the evaluation result may further include reference information.

For example, reference information may be used to describe the degree of accuracy, relevance, and sensitivity. For example, the reference information may include that “The accuracy of the inference is low” or “The inference is wrong”.

For another example, the reference information may include the correct answer. For example, if the question is “What is the solution to the equation 3X+1=4?” and one of the inference sub-tasks is “transposing term calculation” and the inference sub-result is “3X=4,” the reference information may be “The inference is incorrect. The correct answer should be 3X=3.”

For another example, reference information may indicate the reason why an inference sub-result has at least one confidence level. For example, if the confidence level of the relevance of an inference sub-result is 0, the reference information could read, “The question is about solving an equation, while the inference sub-result is about checking airfares. The inference sub-result is irrelevant to the logic of solving the equation.” In this example, the evaluation result includes reference information. This reference information may explain why the inference sub-result has a corresponding confidence level, making the confidence level more reliable. It also provides more information for the inference module to perform the next inference sub-task, effectively correcting errors in the inference module's inference process and improving the accuracy of the inference sub-result for the next inference sub-task.

The above describes the evaluation module and evaluation results.

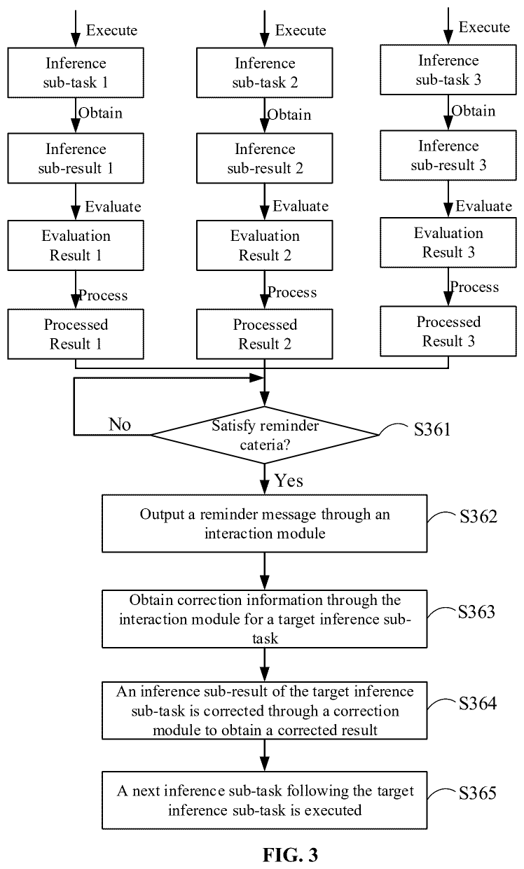

FIG. 3 is a schematic diagram of the principle of manual error correction according to an embodiment of the present disclosure.

In the disclosed embodiment, the inference system may include an inference module, an evaluation module, a processing module, an interaction module, and a correction module.

The inference method of the inference system may include the following operations. First, obtain inquiry information, where the inquiry information corresponds to an inference task, and the inference task includes multiple inference sub-tasks. Based on the inference module, a current inference sub-task in the inference task corresponding to the inquiry information may be executed to obtain an inference sub-result for the current inference sub-task. Then, through using the evaluation module, the inference sub-result may be evaluated to obtain an evaluation result of the inference sub-result. Next, if it is determined that the evaluation result meets processing criteria, the inference sub-result may be processed through the processing module to obtain a processed result for the current inference sub-task.

It should be noted that after a certain inference sub-task is executed through the inference module, the inference sub-task may be called a historical inference sub-task.

During the execution of the inference task corresponding to the inquiry information, multiple inference sub-results are obtained, and each inference sub-result satisfies the processing criteria after being evaluated through the evaluation module. For example, FIG. 3 shows the inference module executing three inference sub-tasks, resulting in three processed results. Next, manual error correction may be performed through operations S361 to S365.

In operation S361, a determination is made as to whether reminder criteria are satisfied. For example, the reminder criteria may include: among multiple historical inference sub-tasks, a target number of consecutive historical inference sub-tasks' inference sub-results have been processed; satisfying the reminder criteria indicates that the target number of consecutive historical inference sub-tasks' inference sub-results have issues with accuracy, relevance, or sensitivity, and that previous error correction attempts were unsuccessful. The target number is, for example, three.

In operation S362, a reminder message is output the interaction module to alert the user that the inference task has an anomaly. In other words, if there are problems with the inference sub-tasks multiple times in a row, the user will be proactively reminded so that the user may adjust the information related to the inference task based on the actual inference situation, thereby improving the accuracy of the inference results.

In addition, information related to the inference task may also be output through the interaction module. This information includes, for example, inquiry information, and may also include sub-task information of each inference task. The sub-task information may include the execution process, the called tools, the input parameters of the tools, the inference sub-results, the evaluation results, etc.

In operation S363, correction information is obtained through the interaction module for a target inference sub-task among the multiple historical inference sub-tasks. For example, after knowing the aforementioned various information, the user may adjust it through the front-end operation interface to obtain the correction information. For example, if the sub-task information of three inference sub-tasks is displayed, if the user adjusts the inference sub-result of the second inference sub-task, the second inference sub-task becomes the target inference sub-task.

In operation S364, the inference sub-result of the target inference sub-task is corrected through the correction module using the correction information to obtain a corrected result of the target inference sub-task. For example, the correction information input by the user may be added to the inference sub-result of the second inference sub-task, or the correction information may be used to replace the inference sub-result.

In operation S365, a next inference sub-task following the target inference sub-task is executed through the inference module based on the revised result of the target inference sub-task. For example, the inference module re-executes the third inference sub-task based on the revised information of the second inference sub-task, thereby adjusting the direction or logic of the inference chain of the inference module and updating the inference results corresponding to the inquiry information.

It should be noted that in the disclosed embodiment, the interaction module outputs a reminder message when the inference sub-results of a target number of consecutive historical inference sub-tasks have been processed. The interaction module then obtains correction information to update the inference results. In some embodiments, even if the inference sub-results of historical inference sub-tasks have not been processed, the user may still adjust the inference task to update the inference results based on actual needs.

By adopting the technical solution provided in the disclosed embodiment, users may adjust the inference sub-results according to actual needs, making the error correction process more flexible, and may correct errors in a timely manner to improve error correction efficiency and the accuracy of inference results.

According to one embodiment of the present disclosure, the inference system further includes an analysis module, and the inference method of the inference system further includes: adjusting prompt information (Prompt) of the inference module based on at least the evaluation result and correction information stored in the analysis module.

For example, the inference module may include a large language model, which may perform inference based on prompt information. Prompt information may be pre-defined, such as a prompt that reads, “You are a large model that helps users solve problems. You may use the following tools: weather, search tools, map tools, translation software, and text and image tools to help users solve problems. You need to think about which tools may solve the user's problem. During the inference process, you need to think about the execution process, then call the tool, and observe the results of calling the tool. The process of thinking about the execution process, calling the tools, and observing the results may be repeated multiple times.”

During the execution of an inference sub-task, the inference module uses the inquiry information, the corresponding prompt information, and the processed result of the previous inference sub-task to execute the next inference sub-task. After obtaining the evaluation result and correction information, the prompt information may be adjusted to make the inference module more accurate.

According to one embodiment of the present disclosure, the inference system further includes an analysis module, and the inference method of the inference system further includes: adjusting parameters of the inference module based on at least the inquiry information and inference results stored in the analysis module.

For example, training samples may be constructed based on historical inquiry information and inference results. In practical applications, the same training sample may contain two inference results, each of which may have different qualities. For example, for the same inquiry information, the inference result obtained based on user correction information may be of higher quality, while the inference result obtained without user correction may be of lower quality. For another example, for the same two inquiry information, two inference results may be obtained by performing inference tasks separately. The quality of these two inference results may be manually labeled. The labels of the training samples may be real-world evaluation values that represent the quality of the inference results.

Next, the inference module may be trained using the training samples. Reinforcement learning may be used, employing an actor-critic architecture. This reinforcement of the learning training process requires pre-training of the reward network. The reward network's inputs include the inquiry information and the inference result, and its output is the predicted value. The predicted value and the label are used to calculate the loss value, adjusting the reward network's parameters until the reward network converges. The reward network may then be used to train the actor network and critic network, with the inference module serving as the actor network.

The disclosed embodiment uses the inquiry information, and the inference result to further reversely adjust the parameters of the inference module, thereby improving the inference accuracy of the inference module.

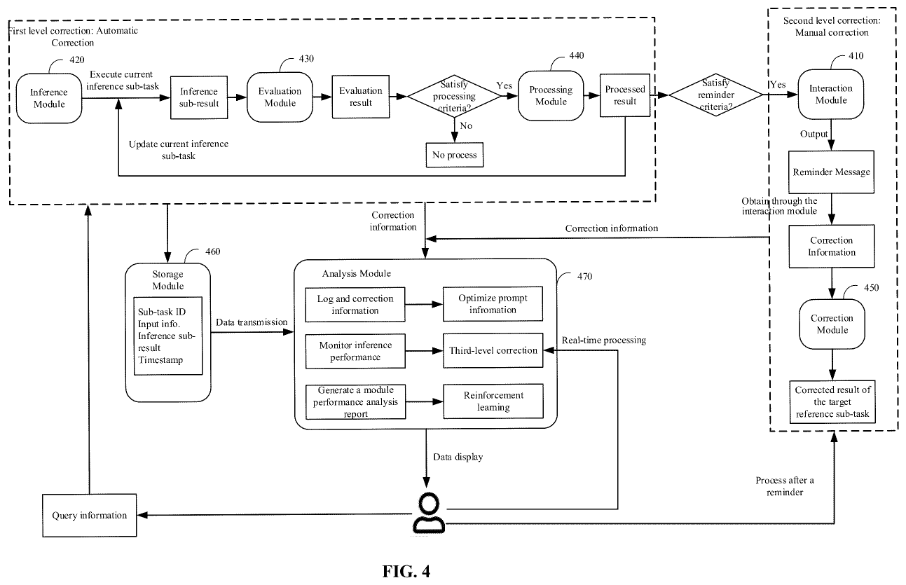

FIG. 4 is a schematic diagram of the inference method of the inference system according to an embodiment of the present disclosure.

In the disclosed embodiments, the inference system may include an interaction module 410, an inference module 420, an evaluation module 430, a processing module 440, a correction module 450, a storage module 460, and an analysis module 470.

The user may input inquiry information through the interaction module 410, and then the inquiry information is input into the inference module 420. Inquiry information corresponds to an inference task one by one. An inference task includes multiple inference sub-tasks, and the multiple inference sub-tasks may be executed in a certain order.

The disclosed embodiment includes a two-level error correction mechanism, where the first-level error correction mechanism is an automatic error correction mechanism, and the second-level error correction mechanism is a manual error correction mechanism.

During the automatic error correction process, for example, the inference module 420 executes the current inference sub-task and obtains an inference sub-result. The evaluation module 430 then evaluates the inference sub-result to obtain an evaluation result. A determination is then made as to whether the evaluation result meets the processing criteria. If not, no processing is performed. If the evaluation result meets the processing criteria, the inference sub-result is processed through the processing module 440 to obtain a processed result. The next inference sub-task may then be updated as the current inference sub-task, and the inference, evaluation, and processing process is repeated.

During manual error correction, for example, after executing multiple inference sub-tasks, it is also possible to determine whether reminder criteria are met. The reminder criteria may include: the inference sub-results of a consecutive target number of historical inference sub-tasks have been processed. If so, a reminder message may be output through the interaction module 410, and then the user's correction information for the target inference sub-task among the multiple historical inference sub-tasks may be obtained through the interaction module 410. Then, based on the correction module 450, the inference sub-result of the target inference sub-task may be corrected using the correction information to obtain a corrected result of the target inference sub-task. Next, through using the inference module 420, the inference sub-task after the target inference sub-task may be executed using the corrected result of the target inference sub-task.

Using this two-level error correction mechanism, when the inference sub-result of an inference sub-task meets the processing criteria, automatic error correction is used to adjust any inference sub-result in the inference chain that may have caused errors. However, if automatic error correction is repeated multiple times, indicating that it has failed to resolve the issue, a manual error correction mechanism is triggered, allowing the user to manually intervene, review, and correct the inference chain. This combination of automatic and manual error correction improves the efficiency of error detection and correction, as well as the accuracy of inference results. It also enhances the monitorability and transparency of the inference module 420.

In addition, the inference system further includes an analysis module 470, which is used to collect data and perform data analysis. The data analysis process may be performed asynchronously with the automatic error correction process and the manual error correction process.

The analysis module 470 may collect data from various processes. For example, during automatic error correction, relevant information about the inference sub-task may be stored by the storage module 460. For example, inquiry information, the identifier of the inference sub-task, input information during the execution of the inference sub-task, the inference sub-result, timestamps, etc., may be stored. The analysis module 470 may then perform analysis based on the information stored in the storage module 460. Furthermore, during automatic error correction, error correction information such as evaluation results may be transmitted to the analysis module 470 for data analysis. Furthermore, during manual error correction, error correction information such as user correction information may be transmitted to the analysis module 470 for data analysis.

After data collection, the analysis module 470 may use the collected data to perform data analysis.

For example, the analysis module 470 may optimize the prompt information. For example, the analysis module 470 may store data such as logs during the inference process, evaluation results during the automatic error correction process, and correction information during the manual error correction process, and then adjust the prompt information based on this data.

For another example, the analysis module 470 may also implement third-level error correction. This differs from the second-level manual error correction described above in that, while the second-level manual error correction determines that the reminder criteria have been met after multiple processing steps, it proactively prompts the user to obtain correction information. The third-level error correction, on the other hand, is not subject to reminder criteria. That is, even if the inference sub-result is not processed during the automatic error correction process, the user may still adjust the relevant information of the inference task according to actual needs.

For another example, the analysis module 470 may also train the inference module 420. For example, the accuracy of the inference module 420 may be analyzed through automatic and manual error correction processes, generating a performance analysis report for the inference module 420. If accuracy is low, reinforcement learning may be used to train the inference module 420. This allows for continuous optimization of the inference module 420, which then reduces errors and enhances the ability and reliability of the inference module 420 to solve complex problems.

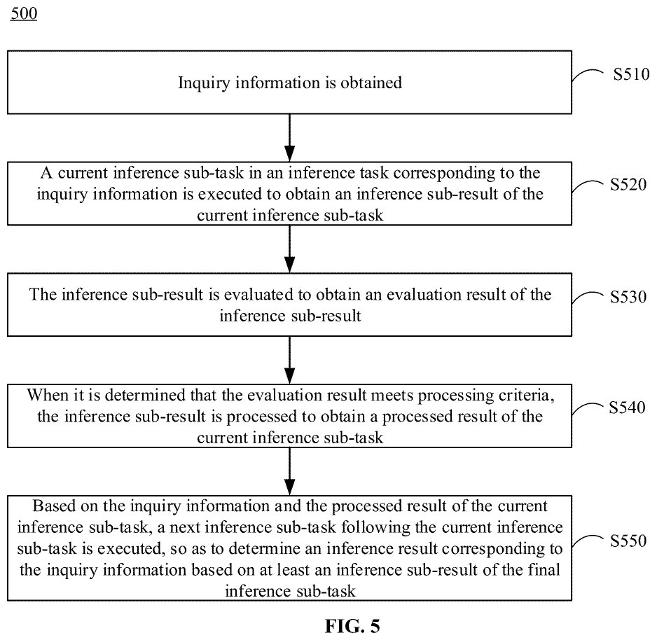

FIG. 5 is a flowchart of an inference method according to an embodiment of the present disclosure.

As shown in FIG. 5, the inference method 500 may include operations S510 to S550.

In operation S510, inquiry information is obtained.

In operation S520, a current inference sub-task in an inference task corresponding to the inquiry information is executed to obtain an inference sub-result of the current inference sub-task.

In operation S530, the inference sub-result is evaluated to obtain an evaluation result of the inference sub-result.

In operation S540, when it is determined that the evaluation result meets processing criteria, the inference sub-result is processed to obtain a processed result of the current inference sub-task.

In operation S550, based on the inquiry information and the processed result of the current inference sub-task, the next inference sub-task following the current inference sub-task is executed to determine an inference result corresponding to the inquiry information based on at least the inference sub-result of the final inference sub-task.

According to one embodiment of the present disclosure, the evaluation result includes at least one of the following confidence levels: a confidence level indicating the correctness of the inference sub-result, a confidence level indicating the correlation between the inference sub-result and the inquiry information, and a confidence level indicating the sensitivity of the inference sub-result. The processing criteria include at least one of the following: a total confidence level determined based on at least one confidence level is less than or equal to a total confidence level threshold, and any one of the at least one confidence level is less than or equal to a corresponding confidence level threshold.

According to one embodiment of the present disclosure, the evaluation result further includes: reference information, where the reference information represents the reason why the inference sub-result corresponds to at least one confidence level.

According to one embodiment of the present disclosure, processing the inference sub-result based on the evaluation result to obtain the processed result of the current inference sub-task includes: adding the evaluation result to the inference sub-result to obtain the processed result of the current inference sub-task.

According to one embodiment of the present disclosure, the method also includes: obtaining correction information for a target inference sub-task among multiple historical inference sub-tasks; correcting the inference sub-result of the target inference sub-task based on the correction information to obtain a corrected result of the target inference sub-task; and executing the inference sub-task after the target inference sub-task based on the corrected result of the target inference sub-task.

According to one embodiment of the present disclosure, the method further includes: when determining that, among the multiple historical inference sub-tasks, inference sub-results of a consecutive target number of historical inference sub-tasks have been processed, outputting a reminder message so as to obtain correction information.

According to one embodiment of the present disclosure, executing the current inference sub-task in the inference task corresponding to the inquiry information to obtain the inference sub-result of the current inference sub-task includes: determining an execution process based on the inquiry information; calling the corresponding tool using the parameters determined based on the execution process; and determining the inference sub-result of the current inference sub-task based on the output information of the tool.

According to one embodiment of the present disclosure, the method further includes: adjusting the prompt information at least based on the stored evaluation results and correction information; where, the next inference sub-task following the current inference sub-task is executed based on the inquiry information, the prompt information corresponding to the inquiry information and the processed result of the current inference sub-task; and/or, adjusting the parameters of the inference module used to execute the inference task at least based on the stored inquiry information and the inference result.

FIG. 6 is a schematic structural block diagram of an inference system according to an embodiment of the present disclosure.

As shown in FIG. 6, the inference system 600 includes an interaction module 610, an inference module 620, an evaluation module 630, and a processing module 640.

The interaction module 610 is configured to obtain inquiry information.

The inference module 620 is configured to execute the current inference sub-task in the inference task corresponding to the inquiry information and obtain the inference sub-result of the current inference sub-task.

The evaluation module 630 is configured to evaluate the inference sub-result and obtain an evaluation result of the inference sub-result.

When it is determined that the evaluation result meets the processing criteria, the processing module 640 is configured to process the inference sub-result to obtain the processed result of the current inference sub-task.

The inference module 620 is further configured to execute the next inference sub-task following the current inference sub-task based on the inquiry information and the processed result of the current inference sub-task, so as to determine the inference result corresponding to the inquiry information based on at least the inference sub-result of the final inference sub-task.

The present disclosure further provides an inference system. The working principle and workflow of the inference system may refer to the inference methods of the inference system mentioned above, which will not be described in detail in the disclosed embodiment.

According to an embodiment of the present disclosure, the present disclosure also provides an electronic device, including at least one processor; and a memory communicatively connected to the at least one processor; the memory stores instructions that may be executed by the at least one processor, and the instructions are executed by the at least one processor to enable the at least one processor to execute the above-described inference methods.

According to an embodiment of the present disclosure, the present disclosure further provides a non-transitory computer-readable storage medium storing computer instructions, where the computer instructions are configured to enable a computer to execute the above-described inference methods.

According to an embodiment of the present disclosure, the present disclosure further provides a computer program product, including a computer program, which implements the above-described inference methods when executed by a processor.

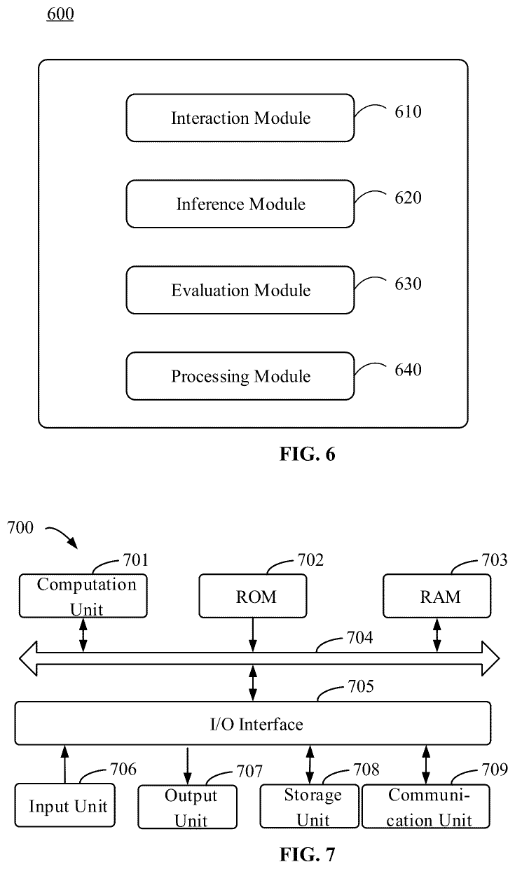

FIG. 7 is a block diagram of an electronic device for implementing an inference method of the inference system according to an embodiment of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistants, cellular phones, smart phones, wearable devices, and other similar computing devices. The components shown herein, their connections and relationships, and their functions are merely for exemplary purposes and are not intended to limit the implementation of the present disclosure described and/or required herein.

As shown in FIG. 7, the electronic device 700 includes a computation unit 701, which may perform various appropriate actions and processes according to a computer program stored in a read-only memory (ROM) 702 or a computer program loaded from a storage unit 708 into a random access memory (RAM) 703. The RAM 703 may also store various programs and data required for the operation of the electronic device 700. The computation unit 701, ROM 702, and RAM 703 are interconnected via a bus 704. An input/output (I/O) interface 705 is also connected to the bus 704.

Various components in the electronic device 700 are connected to I/O interface 705, including an input unit 706, such as a keyboard, mouse, etc.; an output unit 707, such as various types of displays, speakers, etc.; a storage unit 708, such as a magnetic disk, optical disk, etc.; and a communication unit 709, such as a network card, modem, wireless communication transceiver, etc. The communication unit 709 allows the electronic device 700 to exchange information/data with other devices via a computer network such as the Internet and/or various telecommunication networks.

The computation unit 701 may be a general-purpose and/or specialized processing component with processing and computing capabilities. Some examples of the computation unit 701 include, but are not limited to, a central processing unit (CPU), a graphics processing unit (GPU), various specialized artificial intelligence (AI) computing chips, various computation units running machine learning model algorithms, a digital signal processor (DSP), and any suitable processor, controller, microcontroller, etc. The computation unit 701 performs the various methods and processes described above, such as the inference methods. For example, in some embodiments, the inference methods may be implemented as a computer software program tangibly embodied in a machine-readable medium, such as the storage unit 708. In some embodiments, part or all of the computer program may be loaded and/or installed onto the electronic device 700 via the ROM 702 and/or the communication unit 709. When the computer program is loaded into the RAM 703 and executed by the computation unit 701, one or more steps of the inference methods described above may be performed. Alternatively, in other embodiments, the computation unit 701 may be configured to perform the inference methods by any other suitable means (e.g., via firmware).

Various embodiments of the systems and techniques described above may be implemented in digital electronic circuit systems, integrated circuit systems, field programmable gate arrays (FPGAs), application specific integrated circuits (ASICs), application specific standard products (ASSPs), system-on-a-chip systems (SOCs), complex programmable logic devices (CPLDs), computer hardware, firmware, software, and/or combinations thereof. These various embodiments may include being implemented in one or more computer programs that are executable and/or interpreted on a programmable system that includes at least one programmable processor, which may be a special purpose or general purpose programmable processor that may receive data and instructions from a storage system, at least one input device, and at least one output device, and transmit data and instructions to the storage system, the at least one input device, and the at least one output device.

The program codes for implementing the methods of the present disclosure may be written in any combination of one or more programming languages. These program codes may be provided to a processor or controller of a general-purpose computer, a special-purpose computer, or other programmable data processing device so that when the program codes are executed by the processor or controller, the functions/operations specified in the flowchart and/or block diagram are implemented. The program codes may be executed entirely on the machine, partially on the machine, as a stand-alone software package, partially on the machine and partially on a remote machine, or entirely on a remote machine or server.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a RAM, a ROM, an erasable programmable read-only memory (EPROM or flash memory), optical fibers, a portable compact disk read-only memory (CD-ROM), an optical storage device, a magnetic storage device, or any suitable combination thereof.

To provide interaction with a user, the systems and techniques described herein may be implemented on a computer having: a display device (e.g., a CRT (cathode ray tube) or LCD (liquid crystal display) monitor) for displaying information to the user; and a keyboard and pointing device (e.g., a mouse or trackball) through which the user may provide input to the computer. Other types of devices may also be configured to provide interaction with the user; for example, the feedback provided to the user may be any form of sensory feedback (e.g., visual feedback, auditory feedback, or tactile feedback); and input from the user may be received in any form (including acoustic input, voice input, or tactile input).

The systems and techniques described herein may be implemented in a computing system that includes back-end components (e.g., as a data server), or a computing system that includes middleware components (e.g., an application server), or a computing system that includes front-end components (e.g., a user computer with a graphical user interface or a web browser through which a user may interact with implementations of the systems and techniques described herein), or a computing system that includes any combination of such back-end components, middleware components, or front-end components. The components of the system may be interconnected by any form or medium of digital data communication (e.g., a communication network). Examples of communication networks include a local area network (LAN), a wide area network (WAN), and the Internet.

Computer systems may include clients and servers. A client and server are generally remote from each other and typically interact through a communication network. The client and server relationship arises through computer programs running on the respective computers and having a client-server relationship with each other.

It should be understood that the various forms of the processes shown above may be reordered, added, or deleted. For example, the steps described in this disclosure may be performed in parallel, sequentially, or in a different order, as long as the desired results of the technical solutions disclosed in this disclosure may be achieved, which is not limited herein.

The above specific embodiments do not constitute a limitation on the scope of protection of this disclosure. Those skilled in the art will appreciate that various modifications, combinations, sub-combinations, and substitutions may be made based on design requirements and other factors. Any modifications, equivalent substitutions, and improvements made within the spirit and principles of this disclosure shall be included within the scope of protection of this disclosure.

What is claimed is:

1. An inference method for an inference system, comprising:
obtaining inquiry information, wherein the inference system includes an inference module, an evaluation module, and a processing module;
executing, through the inference module, a current inference sub-task of an inference task corresponding to the inquiry information, to obtain a reference sub-result of the current inference sub-task;
evaluating, through the evaluation module, the reference sub-result to obtain an evaluation result of the reference sub-result;
when it is determined that the evaluation result satisfies processing criteria, processing, through the processing module, the reference sub-result to obtain a processed result of the current inference sub-task; and
based on the inquiry information and the processed result of the current inference sub-task, executing, through the inference module, a next inference sub-task following the current inference task, so as to determine an inference result corresponding to the inquiry information based on at least a reference sub-result of a final inference sub-task.

2. The method according to claim 1, wherein:
the evaluation result includes at least one of following confidence levels: a confidence level indicating a correctness of the inference sub-result, a confidence level indicating a correlation between the inference sub-result and the inquiry information, and a confidence level indicating a sensitivity of the inference sub-result; and
the processing criteria include at least one of following: a total confidence level determined based on the at least one confidence level is less than or equal to a total confidence level threshold, and any one of the at least one confidence level is less than or equal to a corresponding confidence level threshold.

3. The method according to claim 2, wherein the evaluation result further includes reference information, and the reference information indicates a reason why the inference sub-result corresponds to the at least one confidence level.

4. The method according to claim 1, wherein processing the inference sub-result based on the evaluation result to obtain the processed result of the current inference sub-task comprises:
adding the evaluation result to the inference sub-result to obtain the processed result of the current inference sub-task.

5. The method according to claim 1, wherein the inference system further includes an interaction module and a correction module, and the method further comprises:
obtaining, through the interaction module, correction information for a target inference sub-task among a plurality of historical inference sub-tasks;
correcting, through the correction module, an inference sub-result of the target inference sub-task based on the correction information to obtain a corrected result of the target inference sub-task; and
executing, through the inference module, an inference sub-task following the target inference sub-task based on the corrected result of the target inference sub-task.

6. The method according to claim 5, further comprising:
when it is determined that inference sub-results of a target number of consecutive historical inference sub-tasks in the plurality of historical inference sub-tasks have been processed, outputting, through the interaction module, a reminder message so as to obtain the correction information through the interaction module.

7. The method according to claim 1, wherein executing the current inference sub-task in the inference task corresponding to the inquiry information through the inference module to obtain the inference sub-result of the current inference sub-task comprises:
determining, through the inference module, an execution process based on the inquiry information;
invoking, through the inference module, a corresponding tool using parameters determined based on the execution process; and
determining, through the inference module, the inference sub-result of the current inference sub-task based on output information of the corresponding tool.

8. The method according to claim 1, wherein the inference system further includes an analysis module, and the method further comprises:
adjusting prompt information of the inference module based on at least the evaluation result and correction information stored by the analysis module, wherein,
the next inference sub-task following the current inference sub-task is executed through the inference module based on the inquiry information, the prompt information corresponding to the inquiry information, and the processed result of the current inference sub-task; and/or,
adjusting parameters of the inference module based on at least the inquiry information and inference results stored by the analysis module.

9. An inference system, including a memory and one or more processors, wherein the memory contains a computer program that, when being executed, causes the one or more processors to perform:
obtaining inquiry information;
executing a current inference sub-task in an inference task corresponding to the inquiry information, to obtain an inference sub-result of the current inference sub-task;
evaluating the inference sub-result to obtain an evaluation result of the inference sub-result;
when it is determined that the evaluation result satisfies processing criteria, processing the inference sub-result to obtain a processed result of the current inference sub-task; and
based on the inquiry information and the processed result of the current inference sub-task, executing a next inference sub-task following the current inference task, so as to determine an inference result corresponding to the inquiry information based on at least an inference sub-result of a final inference sub-task.

10. The system according to claim 9, wherein:
the evaluation result includes at least one of following confidence levels: a confidence level indicating a correctness of the inference sub-result, a confidence level indicating a correlation between the inference sub-result and the inquiry information, and a confidence level indicating a sensitivity of the inference sub-result; and
the processing criteria include at least one of following: a total confidence level determined based on the at least one confidence level is less than or equal to a total confidence level threshold, and any one of the at least one confidence level is less than or equal to a corresponding confidence level threshold.

11. The system according to claim 10, wherein the evaluation result further includes reference information, and the reference information indicates a reason why the inference sub-result corresponds to the at least one confidence level.

12. The system according to claim 9, wherein the one or more processors are further configured to perform:
adding the evaluation result to the inference sub-result to obtain the processed result of the current inference sub-task.

13. The system according to claim 9, wherein the inference system further includes an interaction module and a correction module, and the one or more processors are further configured to perform:
obtaining, through the interaction module, correction information for a target inference sub-task among a plurality of historical inference sub-tasks;
correcting, through the correction module, an inference sub-result of the target inference sub-task based on the correction information to obtain a corrected result of the target inference sub-task; and
executing, through the inference module, an inference sub-task following the target inference sub-task based on the corrected result of the target inference sub-task.

14. The system according to claim 9, wherein the one or more processors are further configured to perform:
when it is determined that inference sub-results of a target number of consecutive historical inference sub-tasks in the plurality of historical inference sub-tasks have been processed, outputting, through the interaction module, a reminder message so as to obtain the correction information through the interaction module.

15. The system according to claim 9, wherein the one or more processors are further configured to perform:
determining, through the inference module, an execution process based on the inquiry information;
invoking, through the inference module, a corresponding tool using parameters determined based on the execution process; and
determining, through the inference module, the inference sub-result of the current inference sub-task based on output information of the corresponding tool.

16. The system according to claim 9, wherein the inference system further includes an analysis module, and the one or more processors are further configured to perform:
adjusting prompt information of the inference module based on at least the evaluation result and correction information stored by the analysis module, wherein
the next inference sub-task following the current inference sub-task is executed through the inference module based on the inquiry information, the prompt information corresponding to the inquiry information, and the processed result of the current inference sub-task; and/or,
adjusting parameters of the inference module based on at least the inquiry information and inference results stored by the analysis module.

17. A non-transitory computer-readable storage medium containing a computer instruction that, when being executed, causes the one or more processors to perform:
obtaining inquiry information;
executing a current inference sub-task in an inference task corresponding to the inquiry information, to obtain an inference sub-result of the current inference sub-task;
evaluating the inference sub-result to obtain an evaluation result of the inference sub-result;
when it is determined that the evaluation result satisfies processing criteria, processing the inference sub-result to obtain a processed result of the current inference sub-task; and
based on the inquiry information and the processed result of the current inference sub-task, executing a next inference sub-task following the current inference task, so as to determine an inference result corresponding to the inquiry information based on at least an inference sub-result of a final inference sub-task.

18. The storage medium according to claim 17, wherein:
the evaluation result includes at least one of following confidence levels: a confidence level indicating a correctness of the inference sub-result, a confidence level indicating a correlation between the inference sub-result and the inquiry information, and a confidence level indicating a sensitivity of the inference sub-result; and
the processing criteria include at least one of following: a total confidence level determined based on the at least one confidence level is less than or equal to a total confidence level threshold, and any one of the at least one confidence level is less than or equal to a corresponding confidence level threshold.

19. The storage medium according to claim 18, wherein the evaluation result further includes reference information, and the reference information indicates a reason why the inference sub-result corresponds to the at least one confidence level.

20. The storage medium according to claim 17, wherein the at least one processor is further configured to perform:
adding the evaluation result to the inference sub-result to obtain the processed result of the current inference sub-task.
